(19) United States
(12) Patent Application Publication
(10) Pub. No.: US 2002/0143610 A1
(43) Pub. Date: Oct. 3, 2002

(54) Computer voting system which prevents recount disputes

(76) Inventor: Robert E. Munyer, Gainesville, FL (US)

Correspondence Address: Robert Munyer, 4324 N.W. 31st Terr., Gainesville, FL, 32605-1409, US

(21) Appl. No.: 10/104,742

(22) Filed: Mar. 21, 2002

Related U.S. Application Data
(60) Provisional application No. 60/277,485, filed on Mar. 21, 2001.

(51) Int. Cl. G06F 17/60

(52) U.S. Cl. 705/12

(57) ABSTRACT

A process for creating an accurate, unambiguous, tangible physical record of the choices made by voters in an election. It includes a two-stage ballot creation process, and a “corrective feedback loop” which causes the two stages to repeat if necessary. In the first stage, a human records votes on a ballot which will be interpreted by a machine. In the second stage, the machine records votes on a ballot which will be interpreted by humans. The machine-generated ballot is always unambiguous, but it may not correctly reflect the voter's intent. If the voter rejects the machine-generated ballot, the process returns to the first stage. This loop does not terminate until an unambiguous, tangible, physical ballot has been created by the machine, and directly perceived by the voter, and approved by the voter. This ballot becomes the official record of the vote, and is preserved for use in recounts.

### CROSS-REFERENCE TO RELATED APPLICATIONS

This application is entitled to the benefit of USPTO Provisional Patent Application #60/277,485, filed Mar. 21, 2001.

### TECHNICAL FIELD

This invention relates to voting systems, specifically to a process which uses a digital computer to create a tangible, physical record of votes that cannot be falsified or erased by defective or malicious software.

### BACKGROUND ART

All of our current voting systems have at least one serious weakness.

The systems which use paper ballots (punch card, optical scan) have an important problem: many voters use the equipment incorrectly, creating ballots which are so ambiguous that two reasonable recount observers can disagree with each other about the voter's intent. If the election is close, and the number of ambiguous ballots is greater than the winning margin, it can be impossible for any kind of recount to determine who actually won the election.

Systems which don't use paper ballots, such as the old lever-operated voting machines, have a more serious problem: a defect in the equipment, accidentally or even deliberately introduced, can cause votes to be recorded incorrectly or not at all. There is no indication to the voter that his or her vote was not recorded. Election officials may be able to determine, after the fact, that a machine was altered—but in most cases there will be no way to recover the information that was lost. Depending on the number of votes affected, this too can make it impossible for any recount to determine the true outcome of the election.

The newest voting machines, based on digital computers, resemble the the old lever machines in one important way. The votes are recorded as invisible “bits” of data, in a form which the voter cannot directly perceive. If a dishonest individual deliberately reprogrammed the machine to record votes incorrectly, he or she could also program the machine to show the correct votes on its display screen even as it's recording the incorrect ones. The voter would never know the difference.

### SUMMARY

This invention solves both of these problems (ambiguous ballots, and software tampering) by introducing a two-stage ballot creation process, and a “corrective feedback loop” which causes the two stages to repeat if necessary. The loop does not terminate until an unambiguous, tangible, physical ballot has been created by a machine, and directly perceived by the voter, and approved by the voter. This ballot becomes the official record of the vote, and is preserved in case a recount will be needed.

### OBJECTS AND ADVANTAGES

When this process is used to collect votes, the most important result at the end of the day is a stack of ballots. These ballots are unambiguous, because they were created by a machine. They do not show any incorrect votes for any reason (including voter ambiguity, hardware defects, or software fraud) because each ballot was seen and approved by the voter whose vote it represents.

If a recount is required, it will proceed quickly and smoothly. The observers from the two parties will agree immediately on each ballot, because there won't be anything to disagree about.

Another advantage of this system is a very high level of voter confidence. It's important to have recounts that are fair and accurate, but it's also important to have a vast majority of voters who know that the recounts are fair and accurate. When a recount begins, every voter can remember the experience of holding a tangible physical ballot, examining it, approving it, and dropping it into the ballot box. The recount process can be understood by anyone, with no need for any computer knowledge whatsoever. With a fully electronic system, the average voter may wonder (with some justification) whether his or her vote could have “disappeared into the ether.”

### DISCLOSURE OF INVENTION

The most important parts of this invention are the two-stage ballot creation process, and the corrective feedback loop that links the two stages together.

At the beginning of the voting process, the prospective voter's right to vote is verified, by using any appropriate technique (for example, this might include verifying identity with a driver's license, and verifying right to vote by finding the name and address on a paper list of the registered voters in the precinct, and requiring a signature next to the name to verify that no one votes twice in a single election).

When the voter's right to vote has been verified, the voter receives a “temporary ballot,” and proceeds to record his or her votes on it. The temporary ballot can be any kind of object on which information can be recorded by a human and then interpreted by a machine. The temporary ballot does not have to be impossible to mark ambiguously (for example, it could be a punch card which the voter perforates with a stylus). Nor does it have to record the votes in a manner that can be directly perceived by a human without the aid of a computer (for example, the temporary ballot could be a handheld digital computer that records votes in its electronic memory).

When the voter has finished recording his or her votes on the temporary ballot, the voter begins the process of exchanging the temporary ballot for a “permanent ballot.” The permanent ballot can be any kind of object on which information can be recorded by a machine and then perceived by a human. Ideally it should be possible for the human to perceive the information without the aid of any kind of equipment at all, because the system's most important protection from fraud is based on the infeasibility of misleading the voter about the votes recorded on his or her permanent ballot. In most situations, the ideal medium for the permanent ballot is just a sheet of paper with the votes printed on it; information that is printed on paper can be perceived directly by most people, and computer printers are cheap and ubiquitous.

In cases where it is impractical to create a permanent ballot which can be interpreted directly without the use of any kind of equipment, it may be acceptable to use some equipment, if it is clear that there is only a vanishingly small chance that the equipment could ever be subverted. For example, consider the case of blind voters: Braille patterns perforated into a sheet of paper would be directly perceivable, but Braille printers are expensive, and recount observers from both parties would have to be able to read Braille in order to be able to count the blind person's votes. In this situation, a good choice of medium for the permanent ballot might be a recordable compact disc, with the voter's choices recorded in digital audio format (created by a text-to-speech synthesis computer program). A ordinary compact disc player would be used to listen to these permanent ballots. This is an acceptable compromise, because the chance that anyone would ever subvert a CD player (for example, by making it play a certain candidate's name when some other candidate's name is actually recorded on the CD) is vanishingly small. Of course, if the blind voter and both recount observers bring their own CD players, there is no risk of subversion.

When the voter decides to exchange his or her temporary ballot for a permanent ballot, a computer is responsible for the task of interpreting the votes that are on the temporary ballot, and recording those same votes on the permanent ballot. This task does not have to be done perfectly. If the voter did something wrong (created an ambiguous ballot, or recorded a vote incorrectly, or even just had a change of opinion) then he or she will be able to reject the unwanted permanent ballot, and exchange it for a temporary ballot, and try again.

If the incorrect information on the permanent ballot was not caused by a voter mistake, but instead was caused by a defect in the voting equipment (whether accidental or deliberately introduced), then the same remedy still applies. The voter can simply reject the permanent ballot and try again.

The two features described above (two-stage ballot creation, and corrective feedback loop) are sufficient to provide safe and unambiguous manual vote counting. Because there are no ambiguous ballots, a manual count or recount could probably be done in about one day. But in most elections there is no need for a recount, and today's voters expect to hear the results of the first count within minutes after the polls close. For this reason, it is valuable to have an “immediate first count” feature, even if that immediate first count is not as thoroughly protected from fraud as a manual count would be.

The current invention does provide an “immediate first count” feature. Each time a voter exchanges a temporary ballot for a permanent ballot, an ID code which uniquely identifies the new permanent ballot is recorded on the permanent ballot, so the new ballot can be distinguished from all the other permanent ballots if the voter decides to reject it. The presence of this ID code makes it possible for the system to

### BRIEF DESCRIPTION OF DRAWINGS

This application is for a process patent; it does not include drawings.

### BEST MODE FOR CARRYING OUT THE INVENTION

How to implement a modern touch-screen voting system that costs even less than punch cards, using equipment that's already available.

When the 2000 election was derailed I started thinking about whether it would be possible to use computer voting to solve the problem of disputed ballots, without creating new computer-related problems that are even worse. A very serious problem with any computer voting system is the possibility that a virus or a dishonest programmer could cause the computer to send in a vote that's completely different from what the voter sees on the screen. If the virus erases all evidence of what the voter saw on the screen, the votes will be lost forever, and no amount of recounting and auditing will ever be able to determine who actually won the election. Furthermore, even if the computers work perfectly, someone could start a rumor about software tampering in the voting system, and the public would never be completely sure that the rumor isn't true. Imagined fraud can taint an election almost as severely as real fraud can.

To solve these problems, I had to invent a system that would make it obvious to everyone (experts and non-experts alike) that you can trust the system even if you don't trust the software. I had plenty of ideas that would solve the problem; unfortunately they all would end up costing hundreds of millions of dollars. But then I finally hit on a solution that doesn't require any specialized equipment at all. It's done entirely with mass-produced consumer products that are already available everywhere. It ends up costing about ONE FOURTH as much as optical scan voting. It's easy to use, it prevents mistakes, and it counts every single ballot on the first try. It never produces an ambiguous ballot, so observers at a recount will never have anything to argue about.

I want to start by explaining the system from the voter's point of view, because that's how most people will experience it. You walk up to table #1, show your ID card to the poll worker, and sign the register just as you've always done. But instead of handing you a paper ballot or a punch card, the poll worker hands you a computer voting machine. It's a PDA or Personal Digital Assistant, running custom voting software. PDAs are sophisticated touch-screen computers that weigh about six ounces, and cost about $150 at any consumer electronics store. That's the retail price; the wholesale price would be even less. If we're worried about theft, we could glue each PDA to a big piece of plastic, like the CD holders in music stores.

The software on the voting machine is extremely easy to use. First, if the ballot is available in more than one language, you see a touch screen with all the language choices (English: touch here; Francais: touchez ici; etcetera). If you choose the wrong language, you can switch back just by touching the name of the right language. After choosing your language you see a few sentences of instructions that explain how to vote. At the top and bottom of the screen are arrows that you can touch to move the ballot up and down. To vote for a candidate, you just touch the candidate's name. Next to each candidate's name is an oval, which is initially hollow. When you vote for a candidate, his or her oval is filled in with solid black. If you touch the words “Write In,” a screen pops up with all the letters of the alphabet; you spell the name by touching letters.

If you try to vote for two candidates in the same race, a message pops up saying that you can't vote for both. Before you can proceed, you have to touch one of three choices: the two candidates you already touched, or a third choice that says you don't want either. After you touch one of the three choices, the warning message goes away, and you can continue voting.

Each race also has an oval for “none of the above,” so if you accidentally touch a name when you really meant to abstain, you'll have a way to undo the error. Every action (whether deliberate or accidental) has an immediate and obvious effect on the screen, and an easy way to take it back if it's not what you intended.

When you reach the bottom of the ballot, you see a message suggesting that you should go back to the top and double-check your votes. You see a touch screen with two choices: “Touch here to go back to the top” and “Touch here when you are finished voting.” If you choose “finished,” a screen pops up and asks if you are sure. If you touch “yes,” the machine locks up (i.e., stops responding to touch) and shows a message saying that you should bring the machine to table #2 and exchange it for your paper ballot.

You walk to table #2 and give the machine to a poll worker, who places it in a device like this one, called a cradle. It's like hanging up a telephone. There's a wire connecting the cradle to another cradle, which holds the poll worker's PDA. Another wire leads to an ordinary, inexpensive (but fast) desktop computer printer. After several seconds a paper version of your ballot comes out of the printer, face down, and lands in a tray right in front of you. This paper ballot is exactly like the ballots used for optical scan voting, except that the ovals are filled in perfectly, and there are bar codes at the bottom, and a few sentences in bold print at the top. The bold print says something like this: “This is your official ballot. Please review it carefully. If everything is correct, put it in the ballot box at table #3 on your way out. If you see any mistakes, DO NOT WRITE on the ballot. Return it to table #2; it will be voided, and you will receive a new voting machine.”

While you are walking away and looking at your paper ballot, the poll worker takes the PDA out of the cradle and puts it in a cardboard box behind the tables. The PDA doesn't need to remember your votes any more, because they're already on paper, so it's been erased and it's ready to be handed to another voter at table #1.

Meanwhile, you are looking at your paper ballot. In most cases it will be exactly what you want, but let's say in this case you change your mind at the last minute. You give your ballot to the poll worker and ask her to void it. She touches something on the screen of her PDA, and then she picks up a hand-held bar code reader like the ones you see at the checkout counters in hardware stores. She scans the bar code at the bottom of the ballot, writes a slash on the ballot with a red highlighter, puts it in the slot of a box behind the table, and hands you a new voting machine so you can start over.

You go through the process again, and when you receive your second paper ballot, you check it and decide that it's exactly what you want. You put it in the ballot box on your way out the door. At the moment when your ballot goes into the box, your vote becomes official and can't be changed. At any time before that moment, you're free to change your vote for any reason.

Now that I've described the voting process, I can explain what makes the system so cheap. The paper ballot looks just like an optical scan ballot, but it DOESN'T ACTUALLY NEED TO BE SCANNED. When the poll workers' PDA transferred the votes from your voting machine to the printer, it also recorded them in its electronic memory. When you rejected your first paper ballot, the poll workers' PDA recorded the cancellation electronically, so the votes on your original incorrect ballot will not be counted. When you accepted your second paper ballot and put it in the ballot box, your correct votes were already stored in the poll workers' PDA, ready to be delivered to the Supervisor of Elections. What all of this means is that we don't have to buy an optical scan machine for each precinct. The ballot box is just a box with a slot and a lock, not an expensive machine. The box will never even have to be opened, unless there's a call for a recount.

When a recount does occur, it will proceed quickly and smoothly, because all the ballots will be filled in correctly and unambiguously. The observers from the two parties will agree instantly on each ballot, because there won't be anything to disagree about. The only exception will be a few rare cases in which a voter brings his own pen or pencil, and writes on the computer-printed ballot. I think this will be very rare, because pens will not be provided.

The paper ballot serves a very important purpose. It protects the integrity of the system against misbehaving computers—regardless of whether the misbehavior is caused by a virus, a dishonest programmer, or an honest mistake. If the PDA voting machine tries to misbehave, it will be caught immediately, because the voter will see that the paper ballot isn't right. If there is any suspicion that the poll workers' PDA or the county's central computer has misbehaved, the voters' true intent can always be determined by counting the paper ballots. The paper ballots are guaranteed to be accurate, because they were seen and approved by the actual voters before they were placed in the ballot box.

I want to emphasize this point, because it's the most important security feature of the whole system: none of the computers can ever destroy the evidence of the voter's real intent, because the evidence is safely stored on paper before the voter leaves the polling place.

Now I want to talk about Internet voting. At first it sounds like a wonderful idea: cast your vote with a few clicks of a mouse, in the privacy of your own home. But when you consider the security issues, Internet voting with today's home computers is a disaster waiting to happen. If it's possible for you to tell your computer to vote for your favorite candidate, then it's also possible for a virus to tell your computer to vote for someone else's favorite candidate. Because the vote leaves your home as an invisible electronic signal, you won't even know it's been changed.

Think about last year's I Love You virus, which sent out millions of phony love letters that appeared to come from real people. Now imagine what would happen to our country if a similar virus hit on election day, casting millions of phony votes that appear to come from real people.

Even if we imagine a future generation of home computers that can't be subverted by viruses or dishonest programmers, Internet voting would still have a serious problem: voting at home means votes can be sold. The buyer can stand right behind the seller, and watch the computer screen during the whole voting process. In contrast, with the voting system I've been describing, the seller has no way to prove that he followed the buyer's instructions—so there's no reason for the buyer to want to make the deal in the first place.

Because of these security problems, my system does not include full Internet voting. Instead I've included a form of partial Internet voting that's completely safe, though unfortunately not as convenient as a fully home-based system.

The Supervisor of Elections web site will have a simulated version of a PDA voting machine, which you can use to practice using the machines. A prominent message, on screen at all times, will warn you that this is only a sample ballot and it does not count as a vote. The sample ballot voting is totally anonymous—the web site makes no attempt to get your name, or verify your eligibility to vote. You can fill out as many sample ballots as you want. When you finish filling out a sample ballot, you'll be given a sample ballot code. This is a number that encodes all of your choices except write-in candidates. You can write this number down and take it along to the polling place, and enter it into the PDA voting machine instead of having to fill in all the votes again. This will save some time so you can get out of the polling place a little faster.

The use of the sample ballot code is completely optional; you are free to change your mind about any vote at any time. The sample ballot code will include check digits, so the voting machine can help you avoid entering the wrong number. If you still manage to get the number wrong, and the wrong votes come up on the screen, you can fix the mistake the same way you fix any other voting mistake. You can fix it right on the voting machine, or if you don't notice it until you get your paper ballot, you can have the ballot voided and start over with a new machine.

That takes care of everything the voter needs to understand. Now I want to explain some things that the Supervisor of Elections needs to understand.

The web site is recommended but optional. It's an ordinary, garden variety, one-way web site. It delivers information to the voter's computer, but does not collect any information from it. The simulated PDA voting machine is a “Java applet,” which means the simulated voting is handled by the voter's computer and not by the web site itself.

The county's central computer, which is used to design the ballots and to count the votes that come back from the precincts after the end of the election, is an ordinary desktop computer.

Here is the minimum equipment that would be required for an average precinct of 2,000 voters. Sixteen low-end PDAs to be used by the voters. One eight-megabyte PDA to be used by the poll workers. Two PDA cradles with USB. One black-and-white USB laser printer. A four-port USB hub, to connect everything together (cost, about $30 retail) . One hand-held USB bar code reader (bar code readers are so cheap, last year Radio Shack was giving them away free to everyone who walked in the door). And a low-tech ballot box, which is just a box with a slot and a lock.

Those would be the absolute minimum requirements; they leave no room for equipment failure. To be safe, we need to add more equipment. Change the four-port USB hub to a fiveport hub, and add a second eight-megabyte PDA with cradle. This PDA will store its own copy of all the votes. If either of these machines dies, the other one will be able to continue functioning while the Supervisor of Elections sends a replacement for the dead one.

It is also possible that the bar code reader or the printer or the hub could die. If the bar code reader dies, the poll worker can just void any unwanted ballots manually, by typing the numbers that are shown below the bar codes, until a replacement bar code reader arrives. But if the hub or printer dies, the whole system stops working. To prevent this, we add a second system—a second laser printer, a four-port USB hub, three cradles and two eight-megabyte PDAs. Both systems can run at the same time, which keeps the lines short. If either system dies, the precinct can run on the remaining system until replacements arrive. We'll also add a couple of voting machines, just to be safe. So now the total requirements for the precinct are: 22 PDAs, six cradles, two laser printers, two USB hubs, and one bar code reader. At wholesale prices the total cost should be a little over $2,000, for a precinct of 2,000 voters.

I should say some more about equipment failures. If a PDA voting machine stops working, the voter can just return it, and start over with another one. If one of the poll workers' PDAs fails, the backup PDA will take over automatically. If the backup fails too, the electronic record of the votes will be lost, and there will have to be a “machine recount” for that one precinct. The machine recount takes place at the Supervisor of Elections office, and it's done by scanning the ballots with the hand-held bar code readers.

We need a way to make sure that voters will not be disenfranchised, even if ALL of the equipment at the precinct breaks down at the same time. (Because of a lightning strike, for example). We can do this by keeping a supply of blank ballots and felt tip pens on hand. It doesn't have to be enough for all 2,000 voters; it just has to be enough to last until replacement equipment arrives. At the end of the day, these emergency ballots will be counted by hand.

I also need to explain how primary elections are handled. Since multiple parties share the same polling places, there needs to be some way to make sure each voter gets the right ballot for his or her party. For a primary, the PDA voting machine shows a choice of parties when it is first initialized. The poll worker chooses a party, by touching its name, before giving the machine to the voter. When this choice is made, the numeric codes for the other parties are actually removed from the machine, so the choice of party can't be changed until the machine is returned to the poll worker and re-initialized.

After the polls have closed, the poll workers' PDAs are brought back to the Supervisor of Elections office. Each PDA in turn is placed in a cradle connected to the county's central computer. The votes are loaded, recorded, and counted in a matter of seconds. The total count is available as soon as this process is complete, unless a serious problem occurred that will require a recount of the paper ballots from one or more precincts.

Notes, about implementation issues:

Do not join the two USB hubs together. We want the two systems to be completely independent, so if something goes wrong in one system, it won't affect the other. To reiterate: one system is a 4-port hub, connected to three cradles and a printer. Two of the cradles are occupied by the poll worker' PDAs, the other is left empty so it can be temporarily occupied by a voting machine. The second system is the same, except that it uses a 5-port hub, and the fifth port is connected to a hand-held bar code reader.

The serial number that identifies the ballot needs to be very well protected. We don't want a clever bad guy to be able to change his bar code with a pen, so someone else's ballot is voided electronically instead of his own. Of course this would be caught in a recount of the paper ballots, but we really don't want it to happen in the first place. If we add seven random digits to the serial number, and check them for accuracy before voiding a ballot, the chance of getting all the digits right would be so low that even if 6 million bad guys tried this trick, it's unlikely that even one of them would get away with it.

In a primary, the number that specifies which party the voter belongs to should also be protected. Otherwise a malfunctioning voting machine could allow someone to vote in the other party's primary. This can also be handled by using random check digits.

The poll workers' PDA stores votes, but it does not count them. It does not display individual votes, or a running tally, or anything like that. The poll workers do not know who voted for whom (neither individually, nor in aggregate). When the poll workers' PDA stores votes, it encrypts them with a public key generated by the county's central computer. This way, even if someone manages to steal one of the poll workers' PDAs, the data it contains will be inaccessible to anyone except the Supervisor of Elections.

We want it to be impossible to connect an individual voter with his or her individual vote, even if bad guys somehow took over the entire computer system. This is no problem with the system I've described, because we use an old-fashioned paper checklist to make sure voting machines are only given to eligible voters who have not already voted. But if we decide to computerize the checklist in the future, we'll want to be careful to make sure it's impossible for the computer to compromise the voter's anonymity.

Note: although these recount techniques can protect against computer tampering, they are not immune to minor accidents. A ballot could get torn or punctured, or an insect could get squashed on a voting oval, causing a ballot to be misread. The original, all-electronic count is capable of attaining a higher level of accuracy, as long as the voting machines have not been tampered with. If it turns out that there has been no tampering, we will be in an unusual situation: we will have an original count that is more accurate than the recount! This leads me to an interesting idea: since each ballot has its own unique bar code number, we can use the computer to check the recount dataset against the original dataset, and flag each ballot that doesn't match, for manual inspection. This way even the tiniest of errors, including squashed insects, can be detected and corrected. Of course, it's very unlikely that an election will be close enough for these tiny errors to matter—but it's good to know that we can get that extremely high level of accuracy if we ever need it.

### RAMIFICATIONS

Note: RCA sells a $300 device called the eBook; it's like a PDA but with a very large touch screen (six times more screen area than a typical PDA). A device like this could be useful as a “large print” version of the voting machine, for people who have poor eyesight or limited use of their fingers. A typical precinct could have sixteen ordinary PDA voting machines, and two of the large-print machines. A precinct with an especially large population of elderly or incapacitated voters would have more of the large-print devices.

Variation: instead of using a small computer that the voter actually carries around, another possibility would be to use an inexpensive computing device that is permanently attached to the voting booth, and records the votes on a “memory unit” that the voter can carry back to the poll workers' table. The memory unit could be a card with a magnetic stripe, an electronic device, or any other kind of inexpensive object that can carry data from one computing device to another. The problem that makes these memory units unsuitable for voting (the fact that the voter can't tell what votes are stored, except with the help of a computing device that the voter doesn't necessarily trust) can be solved by converting the votes to a paper ballot, exactly as I described above. There are a number of inexpensive computing devices that would be suitable, several of which can be found in the toy department! For example, Nintendo's “Game Boy” ($70 retail) or Oregon Scientific's “Zip Learning PC” ($50). Unfortunately, devices like these are not yet available with touch screens. But we could devise a pushbutton user interface that's almost as easy to use as a touch screen, using only three buttons: one for “up,” one for “down,“ and one for “select.”

Another variation: originally I was planning to use ordinary desktop computers to collect the votes from the PDAs, store them in memory, print the paper ballots, etc. Later I realized that PDAs could do this job better and cheaper. I can't think of any advantage of using desktop computers instead, but I decided to mention them here anyway, in case someone else can think of one.

Another variation: if the printer's registration accuracy is good enough, we could print the words on the paper ballots beforehand, so the printer at the polling place only has to print the bar codes and the ovals. This would make the printing at the polling place go faster. Another advantage of preprinting the words on the ballots is that it will simplify the recovery if we ever encounter a situation where sophisticated computer tampering is suspected. If the words were printed and verified in advance, we can be confident that their locations on the page have not been changed, even if the bad guys have somehow taken over the entire system. This means the only thing we need to verify is the location of each of the filledin ovals. This is a purely mechanical activity that does not require the attention of a human being. It could even be done by an Accu-Vote machine! (There wouldn't be an Accu-Vote at every precinct; there would be just one for the whole county, and it would almost never be used. You could even just borrow or rent one from a neighboring county, if you ever encounter a situation where it's needed.)

Another possibility would be to do machine recounts with ordinary desktop computer scanners, equipped with sheet-feeder attachments. I haven't looked into how cost-effective this would be, but I should consider it. In fact, now that I think of it, desktop scanners could even obviate the advantage of pre-printing the words on the ballots. The scanner would digitize the entire page, including the words, and there are image-processing algorithms that could be used to verify that the words themselves have not been tampered with. At the same time, another algorithm would be used to determine which ovals have been filled in, so the computer can recount the votes. I'm starting to like this idea! It allows recounts to be done without specialized equipment or human oversight, yet it still provides an absolute guarantee against voting-machine tampering.

1. A process for creating an accurate, unambiguous, tangible physical record of the choices made by voters, comprising the following steps, which are taken repeatedly and simultaneously as long as the polls are open:
(a) give a “temporary ballot” to each voter whose right to vote has been verified and who has not already been given a temporary ballot;
(b) for each voter who has finished recording votes on a temporary ballot, and wishes to exchange it for a “permanent ballot:”
(1) take said temporary ballot,
(2) examine the information recorded on said temporary ballot,
(3) form an estimate of said voter's intent based on said information,
(4) record said estimate unambiguously on a permanent ballot, and
(5) give said permanent ballot to said voter;
(c) for each voter who has decided to reject a permanent ballot, and wishes to exchange it for a temporary ballot:
(1) take said permanent ballot, and
(2) give said voter a temporary ballot;
(d) for each voter who has decided to approve a permanent ballot, and wishes to use the information on said ballot as said voter's official vote:
(1) take said permanent ballot and place it in the ballot box, or
(2) allow said voter to place it in the ballot box;
whereby: each of the ballots in the ballot box is known to have been approved by the voter for whom it was created, and
whereby: the votes on the ballots in the ballot box are known to have been unambiguously recorded.
